(19) United States
(12) Patent Application Publication
(10) Pub. No.: US 2023/0186406 A1
(43) Pub. Date: Jun. 15, 2023

(54) RateMyPopo website and Mobile Application

(71) Applicants: Munir Vohra, Sugar Land, TX (US); Dwayne Hebb, Saint Louis, MO (US)

(72) Inventors: Munir Vohra, Sugar Land, TX (US); Dwayne Hebb, Saint Louis, MO (US)

(21) Appl. No.: 17/552,183

(22) Filed: Dec. 15, 2021

(51) Int. Cl. G06Q 50/00; G06Q 50/26

(52) U.S. Cl. CPC G06Q 50/01; G06Q 50/26

(57) ABSTRACT

This disclosure relates generally to a systematic method for giving feedback by user as a community member about their interaction with member of a Law Enforcement Agency (LEA) especially police. More specifically, the present invention relates to systems that enable users to send feedback through an app or website and also view the overall feedbacks on interaction of a particular police official. The invention is a software app and a website accessible through mobile and computing devices that allows community member to share their experience of interacting with a police officer in their area and provide feedback with respect to their interaction. The user would be able to able to rate the police officer and the feedback shall be based on real time experience as the user will have to provide the name and badge number of the police officer.

The Abstract of the Disclosure is provided to allow the reader to ascertain the technical disclosure's nature quickly. It is submitted with the understanding that it will not be used to interpret or limit the scope or meaning of the claims. In addition, in the foregoing Detailed Description, it can be seen that various features are grouped in various embodiments to streamline the disclosure.

This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus the following claims are hereby incorporated into the Detailed Description, with each claim standing on its own as a separately claimed subject matter.

### BACKGROUND

### Field of the Invention

The present invention relates generally to online feedback and review system enabled through an app and website but not exclusively, to a system and method for giving a feedback, testimonial, complaint and/or a compliment.

The present invention is directed toward online information systems. More specifically, the invention is directed toward online social feedback system enabled as a community service allowing them to rate and give review on police officers.

### Description of the Related Art

Receiving feedback from consumers is an important business, social and management process. Feedback helps businesses, organizations, societies and government agencies to correct mistakes, find new opportunities, reduce cost, and create value. Likewise, consumers find value in providing feedback about social issues, business, services and ideas. It helps the organizations including governments to improve on different aspects especially with respect to social services.

The most essential feature of any self-regulating, self-correcting, or self-optimizing system is feedback. Without feedback, the systems become stagnant and the users/consumers/learners start or continue to have problems and interfacing within the system. Further, feedback on social, community and security services is the one of the best way to give voice to the society and way forward for improvements.

In the past, the need to collect feedback from consumers, students and especially from society at large was recognized, however, feedback-gathering systems have been inefficient at best. One of the most prevalent problems in prior feedback-gathering systems was the absence of information technology and web enabled services. Another major problem with the feedback system was to gather accurate and worthwhile feedback.

Conventional feedback-gathering methods typically took the form of supplying the audience with a questionnaire or similar response opportunity in physical presence. Further, the user of paper and pencil based feedback system was cumbersome. All feedbacks required from a large audience and on regular basis through the traditional method were difficult and requires good amount of time and resources.

Another drawback in the previous art was to have the feedback through questionnaires long after the service availed, interaction or the problem a user faced. In all such cases, it was difficult for the user to remember the details of a problem, interaction or suggestion.

Another problem in all feedback systems especially related to social issues and interactions was the time convenience to provide feedback at user's choice. Further, the discretion and keeping the user anonymous was another factor. Other reasons why users are not motivated to supply feedback are that users often do not know whom to give the feedback to and are reluctant to provide critical and useful feedback for fear of possible reprisals. The user may want only certain reviewers to receive his or her feedback, but typically has no control over the visibility of the feedback to reviewers.

Previous approaches to providing and receiving feedback to businesses have generally been ad hoc and incomplete. One previous feedback mechanism is the feedback card. This form of feedback fails to take advantage of the speed offered by new technologies. Additionally, the right party in the business for the feedback may not necessarily receive feedback cards. Newer technologies, such as feedback email addresses, may speed the delivery of feedback, but do not ensure that the feedback is received by the appropriate party. There is a need for feedback that is quickly received by the correct party.

Additionally, previous feedback systems failed to direct feedback to the appropriate business unit, social service or even government agency to receive and act on the feedback. For example, a government based organizations and service may have many different business locations. A customer may want to provide feedback about the specific location, provide feedback to certain employees, or provide feedback against interaction or services of a certain individual or area officials. Previously used in-store feedback cards may not provide the consumer a sufficient assurance that the feedback will be seen by corporate. Additionally, previous systems provide little expectation of a timely response.

Further, previous feedback mechanisms failed to provide summary statistics to permit decision makers to leverage feedback to find actionable insights. Accordingly, in the previous art there is a need for a feedback system to send feedback to other users, request feedback from other users, to respond to feedback, and to view summaries and statistics of feedback received, as described herein.

The prior art feedback systems not only have problems in gathering feedback especially for social issues, real time interaction experience with government based agencies especially law enforcement agencies, the previous systems also generally failed to provide an efficient and functional method to gather feedbacks using web based technology.

The current application has the novel feature of gathering feedback by facilitating the user through web portal and mobile application. The user can give their feedback at their own convenience and choice of time. With all previous embodiments in the field did not provide or had limitations on feedbacks systems as a social service for their interaction with officials from law enforcement agencies and the idea itself holds its own novelty.

Thus it has been noted, to Applicant's knowledge, none of these prior art methods is entirely suitable to meet these needs and is cumbersome. Therefore, there is a need in the prior art in which the inconveniences, as mentioned earlier, difficulties, and grooming problems are eliminated for all practical purposes. Thus, the present invention provides such a method, and the overall combination of these features is nowhere disclosed in the prior art cited above, which appears to represent the general art in this area, although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract as a whole.

The present subject matter relates generally to a system for giving feedback by user as a community member about their interaction with member of a Law Enforcement Agency (LEA) especially police. More specifically, the present invention relates to systems that enable users to send feedback through an app or website and also view the overall feedbacks on interaction of a particular police official.

The invention is a software app and a website accessible through mobile and computing devices that allows community member to share their experience of interacting with a police officer in their area and provide feedback with respect to their interaction. The user would be able to able to rate the police officer and the feedback shall be based on real time experience as the user will have to provide the name and badge number of the police officer.

Another embodiment of the invention is that other community members in a specific state and city can view the reviews given to a particular police officer. The user shall have to input name and badge number of that particular police officer and review the comments given by other users.

Another embodiment of the invention is that the feedback system is controlled and governed by code of ethics and guidelines. The users are to abide by those rules for maintaining level of respect and that no police officer is degraded in the process. The system allows the administrator to delete any feedback found against the set rules.

It is accordingly an object of the invention to provide a dedicated web and client application for gathering feedback on the services of police officers in a certain community. The web based application is empowered through a GUI consumer based interface and the feedback is stored and sorted through a database server at the backhand.

Another novel feature of the invention which is based an online feedback system is the gathering of real time experience of community members with police officers of the area. The invention is focused on improving the social interaction and working of the police in the area through community feedback system. Further, while providing a unique social and community service feature the invention overcomes the disadvantages of the heretofore-known devices and methods of this general type and that consumes a minimum of computer and desktop resources and allows a user to passively browse through the application and give their feedback through a computing device of their choice in their own time.

Although the invention is illustrated and described herein as embodied in as a online feedback system which is accessible through web and computer client application, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Other objects, features and advantages of the present invention will be apparent from the accompanying drawing and from the detailed description which follows.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way: Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards online feedback system for rating police officers based on real time interaction experience. The system allows the user to register to the application through a simple registration process and then participate in the feedback system by rating a police officer. The invention further enables the user to rate the officer and their experience on likert scale ranging from (1-5).

The invention, however, is not constrained to use only by subscription or membership. Anyone in the area can give their feedback simply by creating their user name and provision of an email address. By enabling the feature of non-subscription to provide testimonials, feedback and rating the police officer is designed to motivate the users for their input without giving lengthy personal details and receiving newsletters and other related advertising materials.

The invention is based on components of an exemplary environment in which the invention may be used. The online feedback system has focused components and is based on simple to use. Further, the online web based application allows to rate the police officer by giving their opinion on quantitative basis through a likert scale and also to express their ideas, suggestions and feelings through a qualitative mode by narrating their experience. The user can rate the officer anywhere from 1 star to 5 stars. The user can also leave a short review about their interaction and experience with the police officer.

The invention, which is a feedback system to rate police officers can be viewed and used from a personal computer, laptop, PDA or any computing device. In order to use the web based application the user has to be connected to internet to provide the feedback in real time. For real time utility needs to be connected to internet through local area networks (“LANs”)/wide area networks (“WANs”), wireless network or independent internet source. Further, the internet would connect the user to the online feedback application server, through the user's computing or mobile device , where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web based language, including Standard Generalized Markup Language (SMGL), HyperText Markup Language (HTML), and so forth.

Client device may also include mobile computing devices especially the smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like.

The online feedback application which is named as “ratemypopo” is available through a website called RateMyPopo.com and also through an app on the android platform called RateMyPopo. The application can be downloaded easily free of cost from Google Play store. The application shall be available on iOS system by Apple in future. The invention holds its novelty that allows a user to rate a police officer after their interaction.

Another embodiment of invention is that the user search reviews on a particular police officer by entering the officer's last name and badge number or by just the last name or by just the badge number in the required fields. This option allows the user to see if anyone else had reviewed that particular officer as well and the overall rating of the officer given by other users.

Another embodiment of invention implies multiple innovative features which include ability to upload the picture of the officer whose review is to be performed. The system further allows to upload a video of the user's interaction with officer, which allows to make the whole process streamlined and the chances of foul play get minimized.

The system as per its further embodiments provides method for personalizing reviews for a police officer on the platform, comprising the steps of: receiving a rating and a recommendation for a police man, wherein the rating is numerical value in a rating scale, and wherein a recommendation is a binary endorsement. The process also involves receiving a request from a user to view the ratings and recommendations for one or more police officer; and displaying, by a user interface, the rating and recommendation for a police officer.

The invention which is an open forum for providing feedback and rating the police officers in the area are governed by set of guidelines based on code of ethics and privacy policy. The admin has the rights to remove any feedback and remarks which are insulting and against the provided guidelines. The application is focused on improvement of LAE service system and participation of community for the same.

With respect to the process and flow chart of the online feedback web based application also enabled through web portal the first step of the for giving a feedback is to create a user name. Further the feedback app shall require the email address of the user. This process will register the user for providing the feedback w.r.t their interaction with the police officer. Once this process is completed, the user can proceed ahead to for the process of rating and giving feedback.

The second step of the method is selection of the US state where the user resides. Once that is selected the system shall prompt for selection of the city. After this step the user would be able to give feedback about the police officer he/she interacted. The feedback system has a rating system where the user rates the police officer between (1-5) star grading system. Further, the system also provides the provision of sharing the personal experience by narrating the interaction in narrative form in a dialogue box. The dialogue box is set for a certain number of words, which is designed to have the feedback in crisp and meaningful manner.

The online feedback system application is designed for catering the police officers with reference to their place of duty. Each police officer in a city under the state has a unique Badge Number as their ID. The user has to enter the first name, last name and Badge Number for giving the review and rating. This sequence is adopted to ensure that feedback is given in real time against a police officer with whom the user had an interaction. Further, the classification also allow to create a set ID for the police officer and all different feedbacks and reviews given by the user shall be saved and stored in the database with relevance to that specific name and Badge Number.

The next step of the method of setting up a date for an online dating application is shown. When a requested member receives a date request, they will see the “request message” button flashing on their page. This will alert the member that someone has sent a message. When the requested member clicks on the button, the member will be given the choice to either accept the date or decline the date. The requested member can accept or decline by hitting either the “Accept Date” button or “Decline Date” button. This will then send a response back to the requesting member. The requesting member will then see the “request status” button flashing on their page. This will alert the requesting member that they have received a response from their date request.

The system is designed to have two ends. One is the front end which is designed as the front panel with GUI for taking the user's input and the second one is the back end that is the server end. All information entered is stored in the database server according to given format. The same database gives and shares the reviews and ratings of a specific police officer when requested by a user. The user registration is also stored and verified by the same server. The server is also been used to host the site and application. The system “rate my popo” also allows the user to view the reviews and feedback given to a certain police officer by entering the Badge number and name details of the officer under a specific city of the selected state.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

### BRIEF DESCRIPTION OF DRAWING

non-limiting and non-exhaustive embodiments of the present invention are described with reference to the following drawings. The system and method of the present invention will now be described with reference to the accompanying flow chart drawing figure, in which:

FIG. 1 shows a functional block diagram illustrating embodiment of the online & IT based environment for use and giving the basic IT architecture for the application.

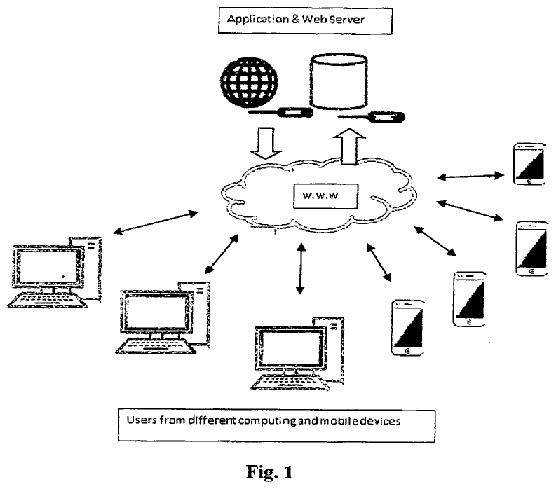

FIG. 2 illustrates a logical flow diagram for giving review on police officer. The flow diagram is for use from mobile or mobile computing device using the mobile based application. The complete process is illustrated from downloading the app to giving review.

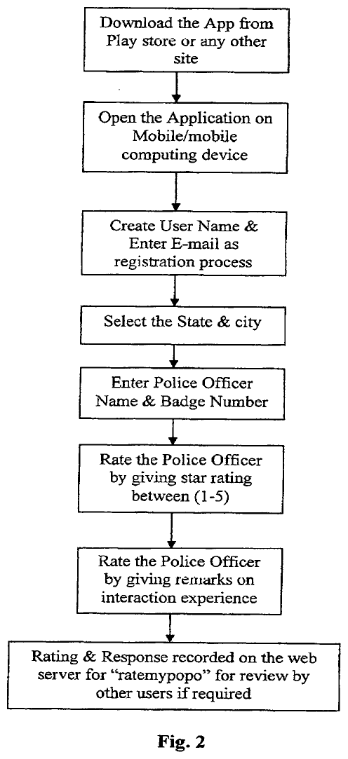

FIG. 3 Illustrates a logical flow diagram for giving review on police officer. The flow diagram is for use from computing device using the website “ratemypopo”. The complete process is illustrated from downloading the app to giving review.

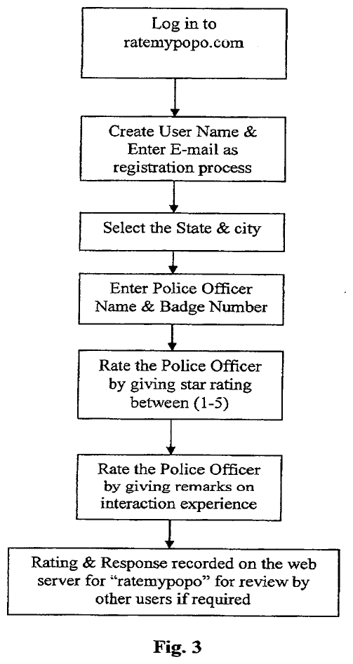

FIG. 4 Illustrates a the process to review the ratings and comments given by other users on a particular police officer. The process is applicable for user using the website or mobile application.

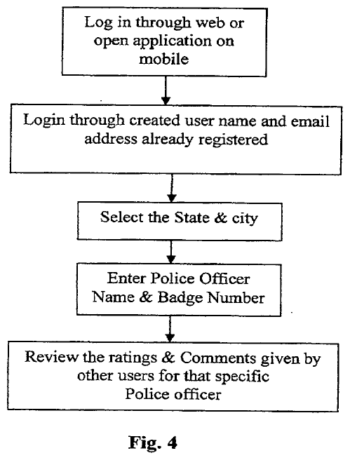

Skilled artisans will appreciate that elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Various alternatives and embodiments are contemplated as being within the scope of the following claims, particularly pointing out and distinctly claiming the subject matter regarded as the invention.

The invention claimed is:

1. An online feedback, rating and review software application which is available through a web portal and any mobile computing device, accessible through an app; which can be downloaded and used at users discretion for rating the police officers in their area through quantitative and qualitative method that is embedded in the application by giving details of the police officer and creating a user name that is validated through their email address.

2. As per claim 1, the application is a unique form of feedback system for rating police officers in the area by the community members.

3. As per claim 1, the application is user friendly and is accessible through any form of computing device by connecting to internet.

4. As per claim 1, the application is a web based software application which is hosted through a server and has its own database for storing and reporting of reviews as per user requirement. Further, the application is designed to protect the privacy through encryption and other software tools.

5. As per claim 1, the invention is a computer-implemented feedback, review and data processing system enabled through a software app comprising a database, server and of user interface for community members in different cities and states of USA. Further the it is a system compromising of a team of admin to ensure smooth and fair reviews in line with the given guidelines and privacy policy.
